(19) United States
(12) Patent Application Publication
(10) Pub. No.: US 2002/0040527 A1
(43) Pub. Date: Apr. 11, 2002

(54) Hand tool for removing material

(76) Inventor: Naftali Hirsch, Nahariyya (IL)

Correspondence Address: Edward Dreyfus, Esq., Stanger & Dreyfus, 608 Sherwood Parkway, Mountainside, NJ, 07092, US

(21) Appl. No.: 09/963,133

(22) Filed: Sep. 25, 2001

(30) Foreign Application Priority Data
Sep. 25, 2000 (DE) 200 16 651.4

(51) Int. Cl. B26B 3/00; B26B 9/00

(52) U.S. Cl. 30/142; 30/353; 30/357

(57) ABSTRACT

The invention relates to a hand tool for removing material, in particular for removing burrs, having a handle (2) and a tool head (1) which can be fastened thereto, this hand tool being developed in accordance with the object in such a way that the surface of a workpiece can be deburred with greater accuracy and damage to the surfaces to be worked due to slight, unintentional tilting of the tool can be essentially avoided.

To this end, the tool head (1) has a first working surface (3) which runs in a curved manner at least in sections and has a predetermined width.

### DESCRIPTION

The invention relates to a hand tool for removing material, in particular for removing burrs, according to the preamble of claim 1.

In the case of mass products, an undesirable material edging may be formed as a result of the production processes used, such as, for example, by various casting, forging, pressing and/or rolling techniques. The causes of this are primarily gaps or other irregularities within the tool molds, from which burrs emerge as a result of excess material or unintentional edgings or parting seams are produced by squeezing. Irregularities on surfaces, edges and/or corners, generally designated as burr herein, may also result from cooling actions, for example following an injection molding process for producing plastic articles. Furthermore, burrs may also be caused, for example, by machining of materials.

In order to achieve, for example, accurately fitting arrangements between individual components or workpieces and to avoid a risk of injury, such undesirable edging formations are removed by material removal, in particular by deburring.

Deburring tools for manual or mechanical deburring are known from the prior art. Such tools normally have a sharp, rectilinear blade.

Japanese Patent Application No. 07 019 790 discloses such a tool which has a blade of ceramic with a rectilinear cutting edge.

A disadvantage with this is in particular that, during the deburring of edges and in particular of flat surfaces, the hand-guided tool may damage the workpiece even during slight tilting as a result of the sharp, even cutting edge.

The object of the invention is therefore to develop a hand tool of the generic type in such a way that the surface of a workpiece can be deburred with greater accuracy and damage to the surfaces to be worked due to slight, unintentional tilting of the tool can be essentially avoided.

This object is achieved in a most surprising manner by a hand tool having the features of the defining part of claim

1. Advantageous and/or preferred embodiments or developments are the subjected matter of the subclaims.

A hand tool for removing material, in particular for removing burrs, is provided for this purpose, this hand tool having a handle and a tool head which can be fastened thereto. The tool head has a first active surface which runs in a curved manner at least in sections and has a predetermined width.

Compared with a rectilinear cutting surface, the curved active surface has in particular the advantage that precise, absolutely accurate material removal is possible.

Depending on whether surfaces or edges are to be worked, an active surface having,a convex or concave curvature is advantageous.

In order to increase the range of use of the hand tool, the tool head has a second active surface which runs preferably parallel to the longitudinal axis of the handle and is designed as an essentially rectilinear knife edge.

In addition, a notch-shaped recess is provided on the tool head, with which notch-shaped recess, for example, sharp pins or edges projecting outwards can be removed, in particular torn off or broken off.

Furthermore, in order to ensure a long service life of the tool according to the invention, even under large mechanical loads, and improved resistance against abrasion and/or wear phenomena, the invention provides for the tool head to be made essentially of ceramic material. In addition, this has the advantage that fiber-glass-reinforced materials can also be worked.

Furthermore, for safety reasons, consideration is given to rounding off the region at which the first and second active surfaces converge at an acute angle, as a result of which dangerous points on the tool head are avoided.

The tool head expediently has a fastening section, for example in the form of a shank, for the detachable fastening to or in the handle, so that a worn or damaged tool head can be changed quickly and simply. In addition, this ensures that tool heads having different specific embodiments can be exchanged in accordance with the required application.

The invention is described below in detail using a preferred embodiment as an example and with reference to the attached drawings, in which:

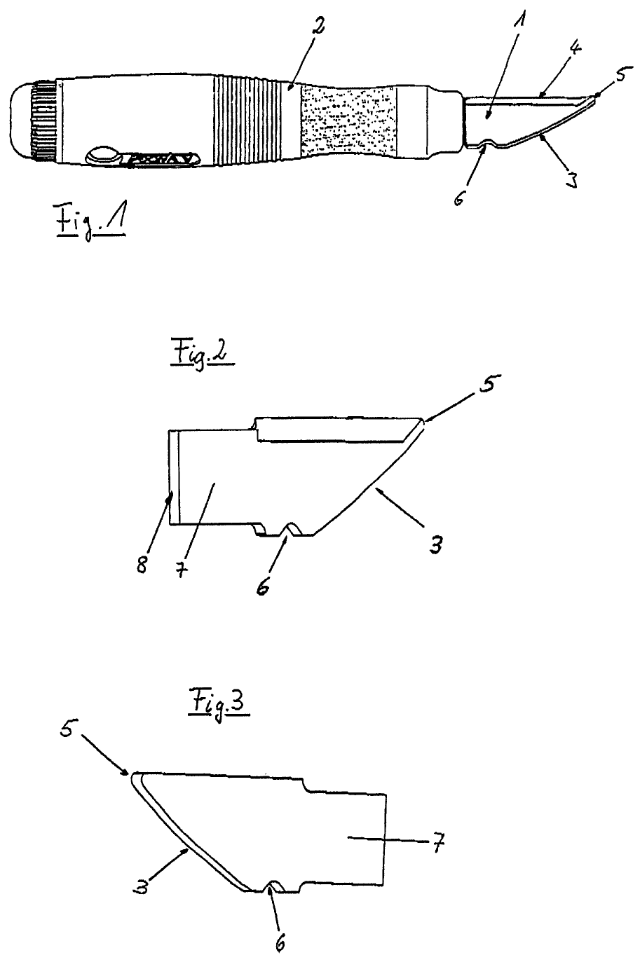

FIG. 1 shows a Bide view of an embodiment of a hand tool according to the invention,

FIG. 2 shows a detail view of the tool head from the same direction of view as FIG. 1, and

FIG. 3 shows a detail view of the tool head according to FIG. 2 as viewed in the opposite direction.

First of all reference is made below to FIG. 1, which shows a preferred embodiment of the hand tool according to the invention. The tool comprises an essentially flat, leaf-shaped tool head 1 which is detachably connected to a handle 2, as described in more detail below. The handle 2 has a shape and a surface which enable a user to hold it with a firm and essentially non-slip grip.

The tool head 1 is described below with additional reference to FIGS. 2 and 3, which show an enlarged detail view of the tool head 1 from the front and rear, respectively. The tool head 1 is made of ceramic material and, on account of the mechanical hardness and resistance achieved by this, is therefore also suitable for working fiber-glass-reinforced plastics for example.

The tool head 1 has a side or edge 4 which runs parallel to the longitudinal axis of the handle 2 and is designed as a knife edge. A further side of the tool head 1 forms a curved working surface 3 which forms an acute angle with the knife edge 4, this acute angle being open toward the handle 2. The working surface 3 has a width which corresponds to the thickness of the leaf-shaped tool head 1, as a result of which the bearing area on the surface of a workpiece to be worked is enlarged relative to the knife edge 4. In the present example, the curvature of the working surface 3 runs convexly, so that projections on the surface to be deburred can be removed in a precise manner, since, as a result of the curvature, pressure is exerted on the workpiece to be worked only at certain spots. Depending on the specific application or on the workpiece to be worked, the tool head 1, as an alternative to or in addition to the convexly curved working surface 3, may also have a concavely curved surface (not shown).

As mentioned, the curved working surface 3 and the rectilinear knife edge 4 enclose an acute angle, the region at their connecting point 5 being rounded off in order to largely rule out injuries to the user, even during improper use.

A section which runs parallel to the longitudinal axis of the handle 2 and in which a notch-shaped recess 6 is formed adjoins the curved working surface 3, with which recess 6 pin-like material projections, in particular, can be removed in a simple manner.

The tool head 1 has a shank 7 which points in the direction of the handle 2 and adjoins the section with the notch-shaped recess 6 and the knife edge 4. The shank 7 can be inserted into a corresponding opening in the handle 2, as shown in FIG. 1.

In an alternative embodiment, the shank 7 may be provided with a through-opening into which a fixing screw, such as a headless set screw for example, can be screwed from outside through the handle 2. However, it may be pointed out that other detachable fastening devices known to the person skilled in the art may also be used for accommodating the tool head 1.

In the embodiment described, the tool according to the invention therefore constitutes a multifunction tool with which many different working steps can be carried out during rework in order to remove material, without the user having to change the tool or exchange the tool head 1 described for another tool head.

1. A hand tool for removing material, in particular for removing burrs, having a handle (2) and a tool head (1) which can be fastened thereto, wherein the tool head (1) has a first active surface (3) which runs in a curved manner at least in sections and has a predetermined width.

2. The hand tool as claimed in claim 1, wherein the first active surface (3) is concavely or convexly curved at least in sections.

3. The hand tool as claimed in claim 1 or 2, wherein the tool head (1) has a second active surface (4) which runs preferably parallel to the longitudinal axis of the handle (2) and is designed as an essentially rectilinear knife edge.

4. The hand tool as claimed in claim 3, wherein the first active surface (3) and the second active surface (4) enclose an acute angle and form a rounded-off region at their connecting point (5).

5. The hand tool as claimed in one of claims 1 to 4, wherein the tool head (1) has a notch-shaped recess (6).

6. The hand tool as claimed in one of claims 1 to 5, characterized in that the tool head (1) is made of ceramic material.

7. The hand tool as claimed in one of claims 1 to 6, wherein the tool head (1) has a fastening section (7) for the detachable fastening to or in the handle (2).
